(19) United States
(12) Patent Application Publication
(10) Pub. No.: US 2012/0201454 A1
(43) Pub. Date: Aug. 9, 2012

(54) SIGNAL PROCESSING DEVICE, SIGNAL PROCESSING METHOD, IMAGING APPARATUS, AND IMAGING PROCESSING METHOD

(76) Inventors: Genta SATO, Kanagawa (JP); Hitoshi NAKAMURA, Kanagawa (JP); Hiromasa IKEYAMA, Tokyo (JP); Motohiro NAKASUJI, Kanagawa (JP)

(21) Appl. No.: 13/362,803

(22) Filed: Jan. 31, 2012

(30) Foreign Application Priority Data
Feb. 7, 2011 (JP) 2011-024392

(51) Int. Cl. G06K 9/00

(52) U.S. Cl. 382/167

(57) ABSTRACT

A signal processing device includes: an enhancement countermeasure unit in which when a linear matrix gain using a linear matrix coefficient is multiplied to a pixel value of an image signal output for each channel by a pixel of an imaging device, whereby an enhancement of color occurs in an image based on the image signal, the image signal in which a portion where the enhancement of color occurs is corrected for each channel is output based on a color-difference component separated from the result of multiplication of the linear matrix coefficient to the pixel value for each channel and a luminance calculated from the result.

### FIELD

The present disclosure relates to a signal processing device, a signal processing method, an imaging apparatus, and an imaging processing method. More specifically, the present disclosure relates to a technique of correcting colored edges (hereinafter referred to as color fringes) occurring at the boundaries of a bright object included in an image.

### BACKGROUND

In the related art, a linear matrix circuit which performs a process of adjusting the gain of a pixel value of an image signal of each of the respective colors red (R), green (G), and blue (B) (hereinafter referred to as “RGB”), read by an imaging device to thereby enhance the color reproducibility such as the hue of an image or the degree of saturation of colors is known. Here, the “color reproducibility” refers to the degree to which an image output to a display device such as a monitor is reproduced in the original color of a subject. Moreover, the process of the linear matrix circuit adjusting the gain of a pixel value is referred to as “multiply a linear matrix gain.”

In an image based on an image signal after multiplying by a linear matrix, colored edges may occur at the boundaries of a bright object. The colored edges are called “color fringes” and the color fringes are conspicuous to the user. The user may recognize the portions where color fringes occur and feel a sense of incongruity. The reasons for color fringes and an example of an image having color fringes will be described with reference to FIGS. 5 to 8B.

FIG. 5 shows an example of colorimetric values when an ideal linear matrix gain was multiplied in an L*a*b* color space. The L*a*b* color space shown in FIG. 5 and FIG. 6 described later represents a coordinate system in which the a* and b* axes are used as the coordinate axes, and the value on the L* axis representing lightness is fixed to a predetermined value.

In the L*a*b* color space, the hue of a pixel changes when the colorimetric value of the pixel moves on the hue coordinates made up of the a* and b* axes. The positive direction of the a* axis represents red, and the negative direction represents blue-green (cyan) or green. On the other hand, the positive direction of the b* axis represents yellow, and the negative direction represents blue. Moreover, the origin is achromatic, and colorfulness increases with the distance from the origin.

It is assumed that when the operation of a linear matrix circuit is off, and a linear matrix gain is not multiplied, a colorimetric point 100 is present at a hue coordinate (a*, b*)=(8, 28). Here, there is a demand to turn on a linear matrix circuit of the related art so that the hue represented by the colorimetric point 100 is set to a color expressed by a colorimetric point 101 of a coordinate (−18, 60).

FIG. 6 shows an example of colorimetric values when a linear matrix gain is actually multiplied in an L*a*b* color space.

As shown in FIG. 6, when the operation of the linear matrix circuit is turned on, and a linear matrix gain is multiplied, an excessively large linear matrix gain may be multiplied so that the resulting hue exceeds the intended colorimetric point 101 and is set to a colorimetric point 102. The change in hue due to multiplication of the linear matrix gain is referred to as “rotation of hue.”

FIGS. 7A and 7B show an example in which a linear matrix gain is so large that color fringes are visible in an image.

FIG. 7A shows an example of an image based on an image signal before multiplying a linear matrix gain.

FIG. 7B shows an example of an image based on an image signal after multiplying a linear matrix gain.

In FIG. 7A, an image which is obtained by imaging a lattice window with bright external light coming therein as a subject in a dark room and which is based on an image signal before multiplying a linear matrix gain is described as an original image. In an enlarged portion 105 of a part of the original image, colors permeate into the boundary between a bright external scene and a dark lattice portion. On the other hand, in FIG. 7B, a linear matrix gain is multiplied to the image signal of the original image, whereby a blue color fringe is enhanced in an enlarged portion 106 corresponding to the enlarged portion 105. Hereinafter, a color fringe with an enhanced tinge visible in, an image as the result of multiplication of a linear matrix gain will be referred to as fringe enhancement.

FIGS. 8A and 8B show a display example in which an excessively large linear matrix gain is multiplied so that a difference in gradation disappears in the portion where the color fringe occurs (this will be referred to as a “collapse of gradation”).

FIG. 8A shows an image based on an image signal before multiplying a linear matrix gain.

FIG. 8B shows an example of an image based on an image signal after multiplying a linear matrix gain.

In FIG. 8A, an image which is obtained by imaging a lattice window with bright external light coming therein as a subject in a dark room and which is based on an image signal in which a linear matrix gain is not multiplied is described as an original image. In an enlarged portion 107 of a part of the original image, a luminance difference is large between a bright external scene and a dark lattice portion. On the other hand, in FIG. 8B, a linear matrix gain is multiplied to the original image, whereby the linear matrix gain is so large in an enlarged portion 108 corresponding to the enlarged portion 107 that the gradation in a lattice portion collapses. Such a collapse of gradation occurs because the level difference between a dark portion and a bright portion is large, and the level difference increases due to multiplication of a linear matrix gain so that the level difference exceeds a level that can be displayed by a monitor or the like. Thus, the image in FIG. 8B can be said to show that a change in gradation of a subject is not sufficiently expressed, and the quality is not favorable.

JP-A-2007-36719 discloses a technique of feeding back the result obtained after adjustment of a linear matrix gain to adjust the gain in high-frequency component of an image signal to thereby reduce noise at positions where the hue changes.

JP-A-2010-178226 discloses a technique of correcting the large slope of Y signal after color separation to thereby reduce color fringes.

### SUMMARY

There are several causes of color fringes. Optical causes thereof include the chromatic aberration of magnification of a prism lens which is provided in front of an imaging device to separate incident light into several colors. Moreover, when the gain of an image is adjusted by a linear matrix circuit, colors may be enhanced due to inherent aberration or light leaking from surrounding pixels. Furthermore, when color fringes occur in a bright portion of an image due to characteristics of an imaging device, “purple fringes” unique to digital images may occur so that purple within an image is enhanced.

Therefore, in order to prevent the occurrence of color fringes, countermeasures have been taken, for example, by performing aberration correction to remove optical causes or improving the quality of an imaging device to perform correction so that no light leaks from surrounding pixels. However, an imaging apparatus includes a number of processing blocks, and a lot of signal processing is performed by respective blocks. Thus, even when the effect of color fringes was removed from an image signal by removing the causes due to optical elements or imaging devices, color fringes were enhanced in an image making process which was performed as a subsequent process.

For example, when image enhancement processing such as white balancing or linear matrix gain control is performed during the image making process, color fringes which have been reduced in advance may be enhanced. Moreover, when an excessively large gain is multiplied to an image signal, fringes may be enhanced, and the hue of a specific color may change in a certain brightness region so that the gradation of an image collapses.

However, the technique disclosed in JP-A-2007-36719 may be unable to deal with problems associated with a collapse of gradation due to rotation of hue. Since this technique performs processing based on a difference signal such as a luminance signal or a color-difference signal, “color fringe countermeasures” for removing the effect of color fringes are effective only in bright regions and are unable to detect a difference in the changes of chromaticity and hue within an image. Moreover, in the color fringe countermeasures, although it is necessary to realize a natural change of hue, it is difficult to change to an intended hue.

Moreover, JP-A-2010-178226 makes no description relating to a technique of performing correction using a linear matrix gain but only discloses a method of interpolating an image signal in a single plate-type imaging apparatus using the Bayer arrangement.

It is therefore desirable to provide a technique of preventing an excessive enhancement of color in a part of an image based on an image signal in which a linear matrix gain is multiplied to a pixel value.

An embodiment of the present disclosure is applicable when an enhancement of color occurs in an image based on an image signal in which a linear matrix gain using a linear matrix coefficient is multiplied to the pixel values of the image signal which are output for each channel by the pixels of an imaging device. The image signal corrected for each channel is output based on a color-difference component separated from the result of multiplication of a linear matrix coefficient to the pixel values for each channel and a luminance obtained from the pixel values.

By doing so, it is possible to correct an excessive enhancement of color occurring in an image based on an image signal in which a linear matrix gain is multiplied.

According to the embodiment of the present disclosure, it is possible to suppress unnatural color fringes by correcting an enhancement of color of an image signal of an image in which a color fringe or a collapse of gradation occurs due to multiplication of an excessively large linear matrix gain.

### BRIEF DESCRIPTION OF THE DRAWINGS

FIG. 1 is a block diagram showing an example of an internal configuration of an imaging apparatus according to an embodiment of the present disclosure.

FIG. 2 is a block diagram showing an example of an internal configuration of an enhancement countermeasure unit according to an embodiment of the present disclosure.

FIG. 3 is a flowchart showing an example of processes for correcting color fringes according to an embodiment of the present disclosure.

FIGS. 4A to 4D are diagrams illustrating an example of an image when color fringe countermeasures are taken according to an embodiment of the present disclosure.

FIG. 5 is a diagram illustrating an example of colorimetric values when an ideal linear matrix gain was multiplied in an L*a*b* color space.

FIG. 6 is a diagram illustrating an example of colorimetric values when a linear matrix gain is actually multiplied in an L*a*b* color space.

FIGS. 7A and 7B are diagrams illustrating an example in which a linear matrix gain is so large that color fringes are enhanced.

FIGS. 8A and 8B are diagrams illustrating an example in which a linear matrix gain is so large that gradation collapses.

### DETAILED DESCRIPTION

Hereinafter, preferred embodiments for carrying out the present disclosure will be described. The description will be given in the following order.

1. Embodiment (Example of correcting color fringes)

2. Modification

### Embodiment

### Example of Correcting Color Fringe

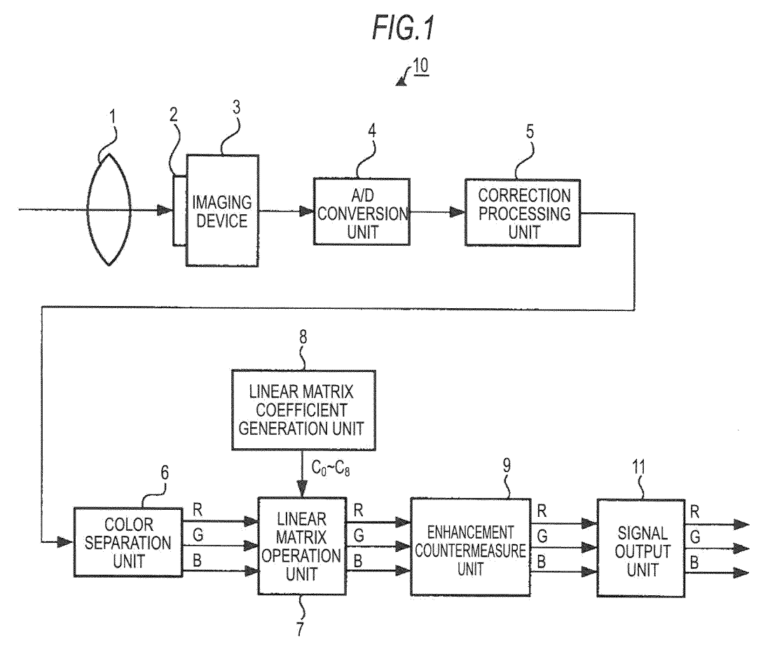

Hereinafter, an embodiment of the present disclosure will be described with reference to FIGS. 1 to 4D. In the present embodiment, an example (hereinafter referred to as a “present example”) in which image signal processing for correcting color fringes occurring in an image is applied to an imaging apparatus 10 will be described. A technique related to the present disclosure is also applied to an imaging processing method executed by the imaging apparatus 10. Moreover, an enhancement countermeasure unit 9 described later is used as a signal processing device that applies predetermined processing to an image signal. This signal processing device is realized by executing the signal processing method performed by the enhancement countermeasure unit 9 as a software program.

FIG. 1 is a block diagram showing an example of an internal configuration of the imaging apparatus 10.

The imaging apparatus 10 includes a lens unit 1, a color filter 2, and an imaging device 3. The lens unit 1 includes an optical lens system and an aperture mechanism (not shown) and forms an image light of a subject on an imaging surface of the imaging device 3. The imaging device 3 has a 2-dimensional arrangement and includes a plurality of pixels that output analog image signals of RGB. As the imaging device 3, a charge coupled device (CCD) imager, a complementary metal oxide semiconductor (CMOS) image sensor, or the like is used, for example.

Color filters 2 of RGB are disposed in the pixels of the imaging device 3, an analog image signal corresponding to one color per pixel is obtained by incident light passing through the color filters 2. When incident light passes through the color filters 2, incident light of the respective color components of the color filters 2 reaches the light receiving unit of the imaging device 3. In this case, in the light receiving unit, incident light of respective components of RGB enters different positions. Moreover, the imaging device 3 reads analog image signals obtained by photoelectrically converting the incident light entering the imaging surface through an optical system and outputs the analog image signals to subsequent processing blocks.

Moreover, the imaging apparatus 10 includes an analog-to-digital conversion unit 4 that converts the analog image signals output by the imaging device 3 into digital image signals and a correction processing unit 5 that performs predetermined correction processing on the digital image signals converted by the analog-to-digital conversion unit 4. The analog-to-digital conversion unit 4 converts the analog image signals of the respective components of RGB output by the imaging device 3 into digital image signals and outputs the digital image signals to the correction processing unit 5. The correction processing unit 5 performs processing such as shading correction for correcting luminance unevenness occurring due to characteristics of an optical system or an imaging system or correction of pixel defects occurring due to defects of the imaging device 3.

Moreover, the imaging apparatus 10 includes a color separation unit 6 that spatially interpolates the image signals output from an imaging device having the Bayer arrangement or the like to obtain full-color image signals of RGB. Furthermore, the imaging apparatus 10 includes a linear matrix operation unit 7 that multiplies a linear matrix gain with the image signals of RGB in accordance with linear matrix coefficients C₀ to C₈ and a linear matrix coefficient generation unit 8 that outputs the linear matrix coefficients C₀ to C₈ to the linear matrix operation unit 7. Furthermore, the imaging apparatus 10 includes the enhancement countermeasure unit 9 that outputs image signals having corrected pixel values when an enhancement of color occurs in an image based on image signals in which a linear matrix gain using linear matrix coefficients is multiplied to pixel values of image signals output for each channel by the pixels of an imaging device. Furthermore, the imaging apparatus 10 includes a signal output unit 11 that outputs image signals of RGB having suppressed color fringes.

The linear matrix operation unit 7 multiplies a linear matrix gain with the pixel values of the image signals output by the color separation unit 6 using the linear matrix coefficients C₀ to C₈ output by the linear matrix coefficient generation unit 8. The enhancement countermeasure unit 9 suppresses an enhancement of color with respect to an image signal output by a pixel where a color fringe or a collapse of gradation occurs among the image signals of RGB in which the linear matrix gain is multiplied. Moreover, the signal output unit 11 applies signal processing corresponding to predetermined transmission standards with respect to the image signals of RGB output by the enhancement countermeasure unit 9 and outputs the image signals of RGB. The image signals of RGB are subjected to image processing such as knee correction, gamma correction, and outline enhancement by an image processing unit (not shown) and output to a display device such as a monitor or an output device such as a printer.

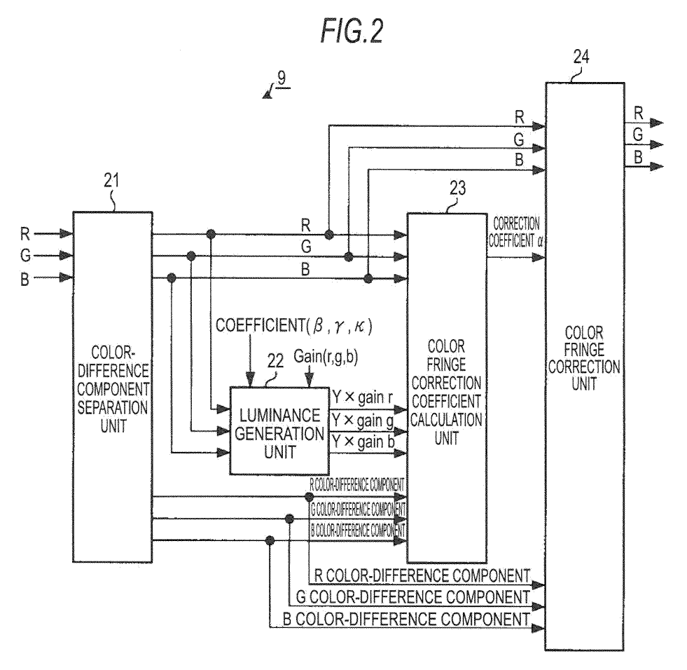

FIG. 2 shows an example of an internal configuration of the enhancement countermeasure unit 9.

The enhancement countermeasure unit 9 includes a color-difference component separation unit 21 that separates a color-difference component for each channel from the pixel values in which the linear matrix coefficients are multiplied. Here, the respective three primary colors of RGB are referred to as “channels.”

Moreover, the enhancement countermeasure unit 9 includes a luminance generation unit 22 that generates a luminance Y such that the value obtained by subtracting the value of a color-difference component from the pixel value of a pixel for each of the RGB channels is not smaller than a predetermined value and a suppression gain for suppressing the luminance Y. Furthermore, the enhancement countermeasure unit 9 includes a color fringe correction coefficient calculation unit 23 that calculates a correction coefficient α for correcting the value of a color-difference component so that the value of a color-difference component added to the pixel value of a pixel of each channel is equal to or greater than the value calculated based on the luminance and the suppression gain. Furthermore, the enhancement countermeasure unit 9 includes a color fringe correction unit 24 that corrects color fringes by adding the value of the color-difference component corrected using the correction coefficient α to correct the pixel value of each channel.

The enhancement countermeasure unit 9 outputs image signals in which portions where an enhancement of color occurs are corrected for each channel based on the color-difference component separated from the result of multiplication of linear matrix coefficients to the pixel value of a pixel of each channel and the luminance calculated from the result. Moreover, when the enhancement of color is a color fringe of a specific color appearing around a bright image or a collapse of gradation where a difference in gradation disappears, the enhancement countermeasure unit 9 calculates a luminance for enhancing the hue of a color opposite to the specific color based on the occurrence condition of the color fringe. Furthermore, the enhancement countermeasure unit 9 calculates a correction coefficient satisfying such a relation that the value obtained by multiplying the color-difference component added to the pixel value of a pixel for each channel with a predetermined correction coefficient is equal to or greater than the value obtained by multiplying a luminance with the color-difference component and corrects the pixel value for each channel using the correction coefficient.

Next, the operations of respective units that realize the function of the enhancement countermeasure unit 9 will be described in detail.

The color-difference component separation unit 21 separates the color-difference components of RGB for each channel of the pixels from the result of multiplication of the linear matrix coefficients with the pixel value of each channel and outputs the color-difference components of RGB to the color fringe correction coefficient calculation unit 23 and the color fringe correction unit 24. Moreover, the color-difference component separation unit 21 outputs the image signals of RGB to the luminance generation unit 22 and the color fringe correction coefficient calculation unit 23.

The luminance generation unit 22 generates a luminance Y such that a color opposite to the color of a color fringe occurring in an image is generated with respect to the image signals of RGB. Moreover, the luminance generation unit 22 outputs a value Y×gain_rgb obtained by multiplying the luminance with predetermined gain coefficients gain_r, gain_g, and gain_b (hereinafter referred to as “gain_rgb”) to the color fringe correction coefficient calculation unit 23. In this case, the luminance Y is calculated based on coefficients β, γ, and κ. The coefficients β, γ, and κ are used for calculating the luminance Y, details of which will be described later. The color fringe correction coefficient calculation unit 23 calculates a correction coefficient α necessary for correcting a color fringe based on the pixel values of RGB, the color-difference components of RGB, and the luminance Y×gain_rgb multiplied with the gain coefficient. The luminance and the correction coefficient α can be varied by a manual operation of the user who uses an operation unit (not shown). For example, by storing the correction coefficient α in a RAM (not shown), the user can change the correction coefficient α or change the luminance Y in conjunction with the aperture information from the outside by operating the operation unit.

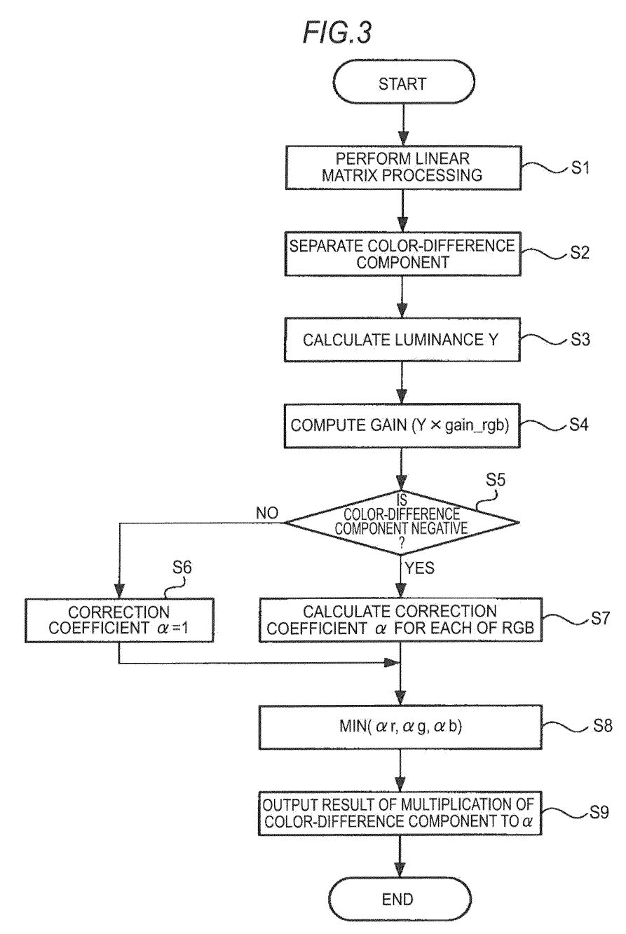

The color fringe correction unit 24 corrects a color-difference component that causes a color fringe from the pixel values of RGB based on the pixel values of RGB, the color-difference components of RGB, and the correction coefficient α and outputs the corrected image signals of RGB to the signal output unit 11. An example of detailed processing of the respective units will be described with reference to FIG. 3.

### (1) Method of Multiplying Linear Matrix Gain

Here, how the linear matrix operation unit 7 multiplies a linear matrix gain with an image signal will be described.

When the linear matrix operation unit 7 multiplies a linear matrix gain with an image signal to adjust the hue or chromaticity of each pixel to thereby perform correction to realize vivid color reproducibility, phenomenon such as an enhancement of color or a collapse of gradation is likely to occur. For example, it is known that when a linear matrix gain is multiplied so as to enhance a blue sky or the like with a vivid color, phenomenon such as a collapse of gradation is likely to occur. A basic expression (1) used when the linear matrix operation unit 7 multiplies a linear matrix gain with image signals of RGB is shown below. The pixel values of image signals of three primary colors in which the linear matrix gain is multiplied are calculated as pixel values of R₁, G₁, and B₁, respectively.

$$( \begin{matrix}{R}_{1} \\ {G}_{1} \\ {B}_{1}\end{matrix} ) = ( \begin{matrix}{C}_{0} & {C}_{1} & {C}_{2} \\ {C}_{3} & {C}_{4} & {C}_{5} \\ {C}_{6} & {C}_{7} & {C}_{8}\end{matrix} ) ( \begin{matrix}R \\ G \\ B\end{matrix} ) \qquad ( 1 )$$

When multiplying a linear matrix gain with the RGB image signals, the linear matrix operation unit 7 multiplies a negative gain with coefficients C₁, C₂, C₃, C₅, C₆, and C₇ and multiplies a positive gain with coefficients C₀, C₃, and C₆.

Focusing on only the gain multiplied to R, since the level of R is low for plain colors such as a blue sky or blue clothes, and the gains of C₁ and C₂ become negative when a positive gain is to be multiplied to C₀, the pixel value of R₁ becomes 0 or less. The pixel value of G₁ also becomes 0 or less. In this case, since only the pixel value of B1 has a positive value, blue is further enhanced in a corrected image. Moreover, since it is not possible to output both pixel values of R₁ and G₁ as values of 0 or less when outputting them to the imaging apparatus 10, both pixel values of R₁ and G₁ are clipped to 0. As a result, the hue of a pixel to be corrected rotates, and since simple blue is the only color which is around the pixel and has the same level as the pixel, and the pixel values of R₁ and G₁ are clipped to be near 0, the gradation of a corrected image collapses.

### (2) General Expression of Image Colors

Next, general expression of image colors will be described.

In order to express the color of each of pixels included in an image, “channel” is determined as a data region that expresses a pixel value of each of the three primary colors of RGB. For example, when the pixel values of RGB are (R, G, B)=(255, 0, 0), a plain color of red can be expressed. Moreover, by combining channels, it is possible to reproduce an arbitrary color and display on a display device such as a monitor. However, although there is an object of which the image is displayed by a channel of one plain color (for example, B) of RGB, there is no object color or no light source color in which the channel becomes 0 by other colors (for example, R and G). Therefore, when an excessively large linear matrix gain is multiplied to an image signal, a plain color of blue which is enhanced excessively may appear to users as an image including an unnatural color.

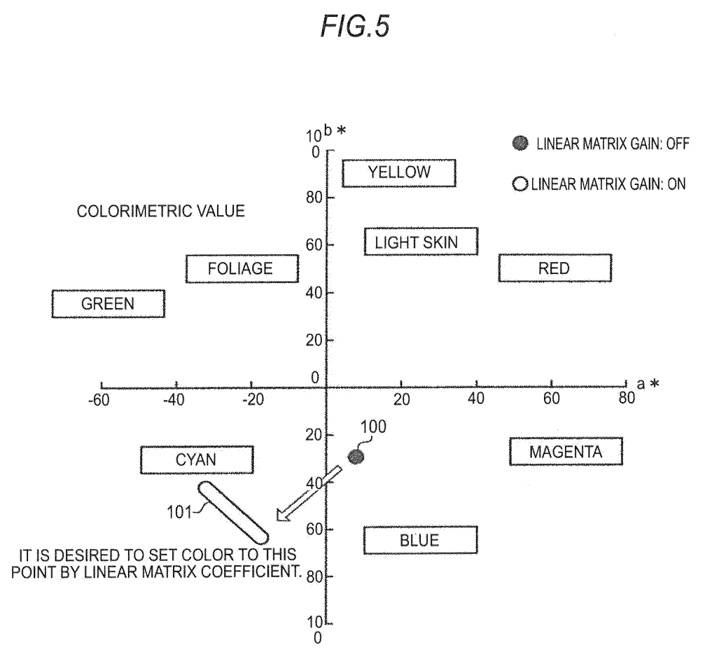

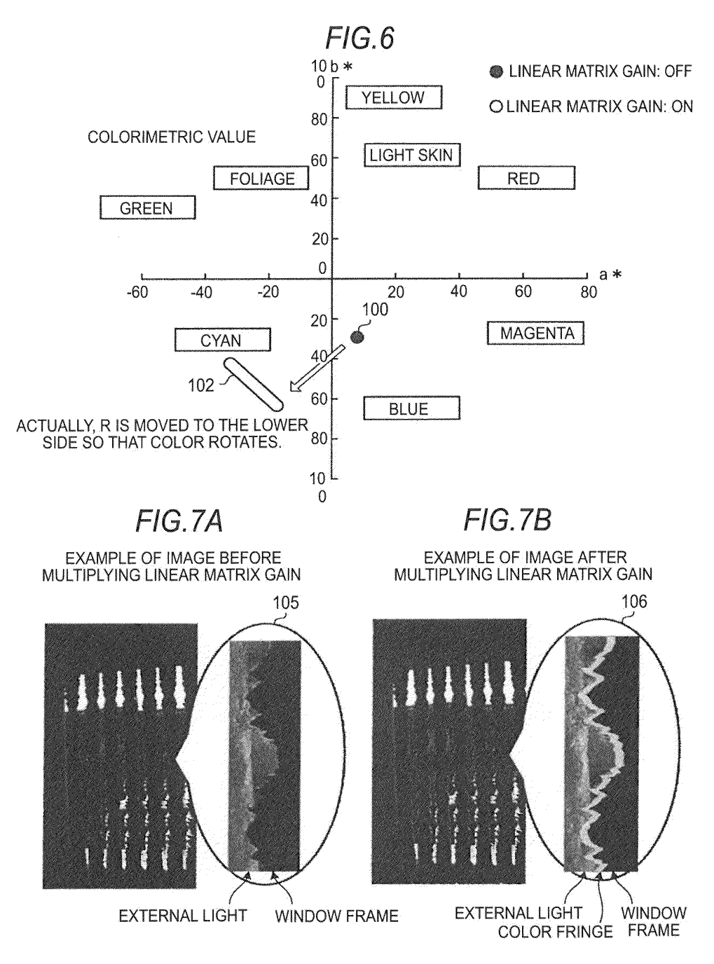

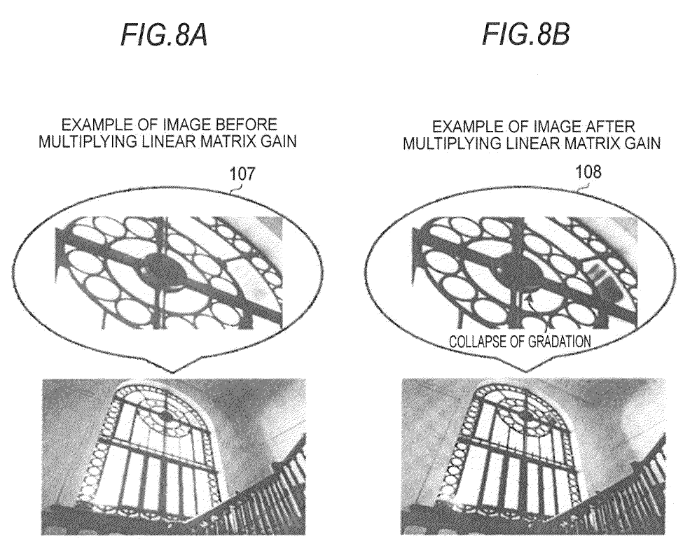

Moreover, as shown in FIG. 5, even when it is desired to change the hue of a pixel, if a linear matrix gain is just multiplied, the hue rotates in a L*a*b* color space as shown in FIG. 6, the fringe may be enhanced. Similarly, when a linear matrix gain is multiplied in order to remove the effect of an aberration from an image, the color is output as aberration such that the color is enhanced into a more plain color. As a result, an image having a collapse of gradation is displayed on a display device. In this case, the user is likely to recognize the excessively enhanced portion within the displayed image as a portion in which an excessively large linear matrix gain is multiplied.

On the other hand, it is not possible to reproduce a desired color even when the amount of the multiplied linear matrix gain is decreased. For other colors (for example, R and G), a blue sky, for example, becomes an unnatural color, and a tinge of sun light reflected from the ground surface is not expressed vividly. Moreover, it is not possible to adjust color reproduction or the like of other objects. The same is true for similar colors. Although gradation collapses in a blue sky having a strong tinge of blue, even if chromaticity is enhanced, an object color or a light source color having a light tinge of blue will not collapse unnaturally since the tinge is light. However, since it is desirable for a portion having a light tinge to have a vivid tinge if possible, it is necessary to multiply a linear matrix gain and then to correct an obtained image signal.

As above, an excessive enhancement due to a color fringe or a collapse of gradation as the result of application of an excessively large linear matrix gain and realization of color reproducibility capable of expressing a light source color and a light object color vividly are in a tradeoff relation. Thus, in a gain matrix circuit of the related art, since there is concern that color fringes may occur, it is not possible to multiply a linear matrix gain so that a light source color and an object color are reproduced vividly. Instead, the gain matrix circuit has only been able to suppress the tinge of an image. However, in the imaging apparatus 10 according to the embodiment of the present disclosure, after the enhancement countermeasure unit 9 multiplies a linear matrix gain with the pixel values of RGB, processing is performed so that an image is expressed vividly while suppressing an enhancement of color occurring in the image.

Hereinafter, an example of processing for correcting color fringes will be described with reference to the flow of processes for correcting color fringes shown in FIG. 3.

(3) Separation of Color-Difference Components after Linear Matrix Operation

First, the linear matrix operation unit 7 performs processing so that the color reproducibility of an image is optimized using Expression (1) above. This processing is linear matrix processing of multiplying linear matrix coefficients C₀ to C₈ using a 3×3 matrix with the pixel values of RGB (step S1).

Subsequently, the enhancement countermeasure unit 9 performs color fringe countermeasure processing for suppressing color fringes on a pixel value corresponding to a pixel where a color fringe occurs in an image.

The color-difference component separation unit 21 included in the enhancement countermeasure unit 9 multiplies a linear matrix gain as shown in Expression (2) in order to determine whether or not to perform color fringe countermeasures to thereby separate pixel values and color-difference components before correction for each of corrected channels (step S2). As for an achromatic color (R=G=B), the conditions of C₀+C₁+C₂=1, C₃+C₄+C₅=1, and C₆+C₇+C₈=1 are satisfied so as to eliminate the effect of a linear matrix gain.

$$( \begin{matrix}{R}_{1} \\ {G}_{1} \\ {B}_{1}\end{matrix} ) = ( \begin{matrix}{C}_{0} & {C}_{1} & {C}_{2} \\ {C}_{3} & {C}_{4} & {C}_{5} \\ {C}_{6} & {C}_{7} & {C}_{8}\end{matrix} ) ( \begin{matrix}R \\ G \\ B\end{matrix} ) = ( \begin{matrix}R - {C}_{1} ( R - G ) - {C}_{2} ( R - B ) \\ G - {C}_{3} ( G - R ) - {C}_{5} ( G - B ) \\ B - {C}_{6} ( B - R ) - {C}_{7} ( B - G )\end{matrix} ) \qquad ( 2 )$$

The color-difference components separated by the color-difference component separation unit 21 are expressed by Expression (3) included on the right side of Expression (2).

−C₁×(R−G)−C₂×(R−B)

−C₃×(G−R)−C₅×(G−B)

−C₆×(B−R)−C₇×(B−G) (3)

When a constant gain is set so as to increase color-difference components, the color moves in the increasing direction of chromaticity with no change in the hue of pixels. That is, if it is possible to control the gain multiplied to color-difference components, it may also be possible to suppress chromaticity without rotating colors. In this case, if it is possible to determine a pixel where a color fringe occurs, it is possible to eliminate a collapse of gradation or an enhancement of fringe by weakening the gain of an image signal corresponding to the pixel.

### (4) Calculation of Level Serving as Occurrence Condition of Color Fringes

Although color fringes can be suppressed by suppressing only the color-difference components shown in Expression (2), the luminance generation unit 22 sets the occurrence conditions of color fringes. Examples of the causes of a collapse of gradation or an enhancement of color fringes due to multiplication of a linear matrix gain include the pixel values expressed by the channels of RGB, which have values of 0 or smaller, whereby the hue of pixels are changed. Here, the phenomenon in which when a linear matrix gain is multiplied to an image signal, the pixel value of a certain channel has a value of 0 or smaller will be referred to as a “collapse of channel.”

For example, if there is one channel satisfying Expression (4) corresponding to the right side of Expression (2), an unnatural image in which the gradation collapses is displayed on a display device.

R−C₁×(R−G)−C₂×(R−B)<0

G−C₃×(G−R)−C₅×(G−B)<0

B−C₆×(B−R)−C₇×(B−G)<0 (4)

Since the color of an image displayed in a state where the channel collapses toward the lower side in the L*-axis direction perpendicular to the a*-b* coordinate system of an L*a*b* color space, and the brightness decreases, the hue is also changed. Although pixel values having a negative sign are also held in various kinds of circuits and blocks included in the imaging apparatus 10, the pixel values of channels are clipped to values of 0 or smaller when image signals are output to a display device or an output device. This is because the image displayed by the display device or output by the output device is expressed in the range of pixel values of 0 or more, if the pixel value is 0 or smaller, the channel collapses whereby the brightness of an image decreases. The phenomenon of a collapse of gradation may occur in any display device and any output device.

Therefore, the luminance generation unit 22 sets gain_rgb as a suppression gain for suppressing a gain before the pixel values of channels are decreased to 0 or smaller and also calculates the luminance Y. Moreover, the luminance generation unit 22 sets a condition where a luminance becomes equal to or smaller than Y×gain_rgb as the occurrence condition of color fringes such as a collapse of gradation.

The luminance generation unit 22 recognizes that the hue of a pixel rotates so that a color fringe occurs when there is one channel including a pixel value satisfying the occurrence condition of color fringes shown in Expression (5).

R+(−C₁(R−G)−C₂(R−B))<Y×gain_{—}r

G+(−C₃(G−R)−C₅(G−B))<Y×gain_{—}g

B−C₆×(B−R)−C₇(B−G))<Y×gain_{—}b (5)

Moreover, the luminance generation unit 22 generates a luminance Y of an image signal based on Expression (6) (step S3). The coefficients β, γ, and κ used in Expression (6) are free coefficients and are variable depending on the color of a color fringe.

Y=β×R₁+γ×G₁+κ×B₁ (6)

For example, when a blue fringe where blue is enhanced occurs, a pixel value for enhancing magenta (R and G channels) which is the opposite color of blue is set to the luminance Y. Therefore, the free coefficients can be varied depending on the color of a color fringe occurring in an image like β=0.5, γ=0.5, and κ=0.

Moreover, the luminance generation unit 22 can freely change the level of the luminance Y for determining the occurrence condition of color fringes by setting gain_rgb as the suppression gain. For example, when gain_rgb is set to 0, a condition where a pixel value of each channel arranged on the left side of Expression (5) is smaller than 0 becomes the occurrence condition of color fringes. Moreover, when the value of gain_rgb is increased, the value of Y×gain_rgb also increases, the occurrence condition of color fringes is likely to be satisfied for many images. In this way, the luminance generation unit 22 sets the luminance Y and Y×gain_rgb which serve as the occurrence condition of color fringes.

### (5) Method of Controlling Color Fringes

Subsequently, the color fringe correction coefficient calculation unit 23 defines a correction coefficient α which the color fringe correction unit 24 multiplies with the color-difference components separated by Expression (1). The correction coefficient α is used by the color fringe correction unit 24 for weakening the effect of linear matrix coefficients in Expression (9) described later. The color fringe correction coefficient calculation unit 23 calculates the gain (Y×gain_rgb) in order to correct color fringes (step S4).

Subsequently, the color fringe correction coefficient calculation unit 23 adjusts the value of the correction coefficient α and controls so that no color fringe occurs in an image. In this case, the color fringe correction coefficient calculation unit 23 determines whether the color-difference component output by the color-difference component separation unit 21 is negative or not (step S5). When the color-difference component is 0 or positive, the correction coefficient α is set to 1 (step S6). On the other hand, when the color-difference component is negative, the correction coefficient α is calculated for each channel of RGB.

The correction coefficient α moves in the range of 0 to 1, and as the influence rate of color fringes increases, the correction coefficient α approaches 0 to thereby weaken the effect of a linear matrix gain. On the other hand, as the correction coefficient α approaches 1, the influence rate of color fringes in an image is determined to be small, and the effect of a linear matrix gain is maintained.

The correction coefficient α can be controlled by several methods. However, if the correction coefficient α is calculated using a threshold value (Y×gain_rgb) or a difference value (Y-R, Y-G, and Y-B) of the levels of the respective channels, the luminance level of a pixel also changes, and the value of the correction coefficient α changes depending on the luminance. In this case, it is difficult to perform effective color fringe countermeasures in portions where the luminance level is low. Therefore, the color fringe correction coefficient calculation unit 23 sets a “lower-limit level” which is a threshold value for correcting the level of a luminance for each channel using the result of multiplication of a linear matrix gain to pixel values. The correction coefficient α is set with respect to a luminance of a channel, which is lower than the lower-limit level, among the channels of RGB. The correction coefficient α is a value which will not be equal to or smaller than the lower-limit level even when a linear matrix gain is multiplied. Moreover, the color fringe correction coefficient calculation unit 23 feeds back the result of multiplication of the linear matrix gain to the respective colors RGB to thereby calculate the correction coefficient α for each channel while monitoring the lower-limit level. In the present example, the lower-limit level at which color fringes occur is a value obtained by multiplying the suppression gain gain_rgb with the luminance Y.

Expression (7) satisfying the above condition is shown below.

R+αr×(−C₁(R−G)−C₂(R−B)≧Y×gain_{—}r

G+Δg×(−C₃(G−R)−C₅(G−B)Y×gain_{—}g

B+αb×(−C₆(B−R)−C₇(B−G)Y×gain_{—}b (7)

In this case, the color fringe correction coefficient calculation unit 23 sets the correction coefficient α for each channel so that the result of the multiplication of linear matrix coefficients to pixel values is not smaller than Y×gain_rgb. Here, the color fringe correction coefficient calculation unit 23 calculates the correction coefficient α satisfying Expression (7) by computing Expression (8) below for extracting the minimum value from the correction coefficients αr, αg, and αb of the respective channels (step S8). Here, the MIN function is a function of extracting the minimum value from a plurality of values.

α=MIN(αr,αg,αb) (8)

The color fringe correction coefficient calculation unit 23 calculates the smallest correction coefficient among the correction coefficients αr, αg, and αb as a correction coefficient α common to a plurality of channels so as to satisfy Expression (8). By calculating the correction coefficient α in this way, no color fringe occurs in a pixel of any channel and the inequality expression (7) for determining color fringes is satisfied for any channel. However, the color fringe correction coefficient calculation unit 23 does not calculate the correction coefficient α unless the color-difference component becomes negative. This is because, if the condition that the color-difference component is negative is not satisfied, it means that the result of multiplication of linear matrix coefficients to pixel values is always a positive integer, and thus, the pixel values do not collapse toward the lower-limit direction. In this case, the correction coefficient α is always 1. Here, if the pixel value increases, the colors may collapse in the upward direction. However, in this case, since a knee correction circuit, a gamma correction circuit, or the like of the image processing unit (not shown) sets a curve so that the pixel values do not collapse in the upward direction, the enhancement countermeasure unit 9 does not perform correction.

### (6) Method of Correcting Color Fringes

After that, the color fringe correction unit 24 calculates the pixel values (R₁, G₁, B₁) for each channel of RGB using the correction coefficient α calculated by the color fringe correction coefficient calculation unit 23 as shown in Expression (9) below (step S9). In this way, by multiplying the correction coefficient α with the color-difference components, it is possible to weaken the effect of linear matrix coefficients.

R₁=R+α×(−C₁(R−G)−C₂(R−B)≧Y×gain_{—}r

G₁=G+α×(−C₃(G−R)−C₅(G−B)≧Y×gain_{—}g

B₁=B+α×(−C₆(B−R)−C₇(B−G)≧Y×gain_{—}b

### (7) Setting Example

When the color fringe correction unit 24 corrects a blue fringe using the calculation shown in Expression (9), the parameter gain_rgb may be adjusted so that only the level of a pixel having a color opposite to blue-like colors does not collapse toward the lower-limit direction of the pixel values. That is, by setting gain_b=0, no unnecessary determination criterion is included in the pixel value of the B channel. Here, since the probability to determine that color fringes occur in an image increases as the values gain_r and gain_g increase, it is possible to suppress an enhancement of color in a portion where a blue fringe occurs, to which a linear matrix gain is multiplied. In this case, it is possible to obtain an effect that blue is not unnaturally enhanced due to multiplication of an excessively large linear matrix gain.

As above, as for a purple fringe, the color fringe correction unit 24 sets the gain so that gain_r=0 and gain_b=0 and increases gain_g to thereby suppress a color fringe. In this way, in a pixel where a purple fringe occurs, the image is not excessively enhanced due to multiplication of an excessively large linear matrix gain.

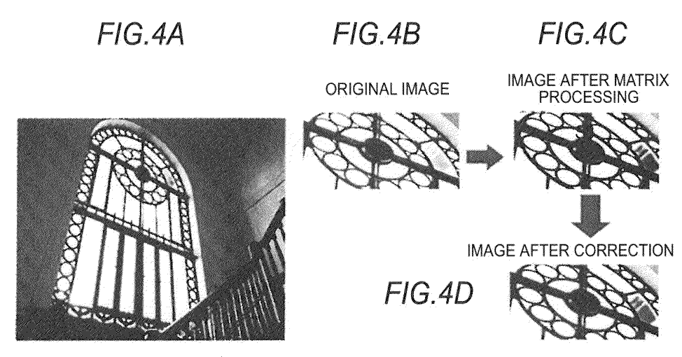

FIGS. 4A to 4D show an example of an image in which a color fringe is corrected.

FIG. 4A shows an image including a lattice window imaged in a room as a subject, and FIG. 4B shows an enlarged image of the lattice.

FIG. 4C shows an image obtained by multiplying a linear matrix gain with the enlarged image of FIG. 4B.

As the result of multiplication of a linear matrix gain, a difference in shading of the lattice disappears, and the color reproducibility is decreased.

FIG. 4D shows an image obtained by the enhancement countermeasure unit 9 performing color fringe correction on the enlarged image of FIG. 4C.

As the result of correction of color fringes, a difference in shading is visible in the lattice of the corrected image, and the color reproducibility is increased.

The enhancement countermeasure unit 9 according to the embodiment described above corrects the pixel values so as to suppress the occurrence of color fringes with respect to the RGB channels of a pixel where a color fringe occurs as the result of multiplication of a linear matrix gain. The process of suppressing color fringes performed by the enhancement countermeasure unit 9 is not a process of removing a color fringe occurring due to color separation performed by the color separation unit 6 but a process of reducing an excessive enhancement of color occurring in the image due to the linear matrix gain. Therefore, the color fringe suppression process is effective not only in an image of a bright object but also an image in which color reproducibility is decreased due to various reasons such as leakage of noise associated with various sensors into image signals or the occurrence of moire resulting from the effect of aberration or color separation of the lens unit 1. In this case, the linear matrix operation unit 7 can increase the color reproducibility of an image by multiplying a linear matrix, and the enhancement countermeasure unit 9 can maintain the color reproducibility which is increased by multiplying a linear matrix gain.

Moreover, when suppressing color fringes, the enhancement countermeasure unit 9 focuses on pixel values in which colors in an image change unnaturally or collapse abruptly so that the hue changes but does not focus on pixels of which the value of luminance or chromaticity is great. However, since there is an effect of suppressing the gain of luminance, it can be said that it leads to reduction of noise caused by an excessively large linear matrix gain rather than reduction of existing noise.

Moreover, the process performed by the enhancement countermeasure unit 9 does not aim to remove color fringes occurring due to color separation. Moreover, the process does not aim to perform coloring correction of whiteout occurring in a high luminance range when a bright portion such as a metallic luster is imaged. Instead, the process aims to correct a collapse of gradation or an enhancement of fringe in any one of the RGB channels regardless of whether a high luminance range is present in the image. When an overflow of luminance which could not be expressed by a display device or an output device occurs due to the presence of a high luminance range in the image, it may be dealt with knee correction or gamma correction in the subsequent processing blocks.

### 2. Modified Example

In the above-described embodiment, an example applied to the imaging apparatus 10 in which the linear matrix operation unit 7 and the enhancement countermeasure unit 9 are provided has been described, however the present disclosure is not limited to this embodiment. For example, the linear matrix operation unit 7 and the enhancement countermeasure unit 9 may be separated from the imaging apparatus 10 and used as independent signal processing devices. In this case, rather than processing video in real time, image signals read from an external storage device, for example, may be corrected. Moreover, although FIG. 1 illustrates an example in which the imaging apparatus 10 includes the lens unit 1, the lens unit 1 may be detachable from the imaging apparatus 10.

Moreover, although a series of processes in the above-described embodiment can be executed by hardware, the processes may be executed by software. When the series of processes are executed by software, the processes can be executed by a computer in which programs constituting the software are incorporated into dedicated hardware or a computer in which programs for executing various functions are installed. For example, the processes may be executed by installing programs constituting desired software into a general-purpose personal computer, for example.

A recording medium in which program code of software that realizes the functions of the above-described embodiment are recorded may be supplied to a system or an apparatus. Moreover, the functions may be realized when the computer (or a control device such as a CPU) of the system or the apparatus reads and executes the program codes stored in the recording medium.

In this case, as the recording medium for supplying the program codes, a flexible disk, a hard disk, an optical disc, an optomagnetic disc, a CD-ROM, a CD-R, a magnetic tape, a nonvolatile memory card, a ROM, and the like can be used, for example.

Moreover, the functions of the above-described embodiment are realized by executing the program codes read by the computer. In addition, a part or an entire part of the actual processes are performed by an OS or the like running on the computer based on instructions of the program codes. The functions of the above-described embodiment may also be realized by the processes.

Furthermore, the present disclosure is not limited to the above-described embodiment, and various other application examples and modified examples can be made without departing from the spirit of the present disclosure disclosed in the appended claims.

The present disclosure can be implemented as the following configurations.

(1) A signal processing device including: an enhancement countermeasure unit in which when a linear matrix gain using a linear matrix coefficient is multiplied to a pixel value of an image signal output for each channel by a pixel of an imaging device, whereby an enhancement of color occurs in an image based on the image signal, the image signal in which a portion where the enhancement of color occurs is corrected for each channel is output based on a color-difference component separated from the result of multiplication of the linear matrix coefficient to the pixel value for each channel and a luminance calculated from the result.

(2) The signal processing device according to (1), wherein when the enhancement of color is a color fringe of a specific color occurring around the image corresponding to a high luminance pixel or a collapse of gradation where a difference in gradation disappears, the enhancement countermeasure unit calculates a luminance that enhances a color opposite to the specific color, calculates a predetermined correction coefficient satisfying a relation such that a value obtained by multiplying the color-difference component added to a pixel value of the pixel of each channel with a predetermined correction coefficient is equal to or greater than a value obtained by multiplying the color-difference component with the luminance, and corrects the pixel value for each channel using the correction coefficient.

(3) The signal processing device according to (1) or (2),

wherein the enhancement countermeasure unit includes

a color-difference component separation unit that separates a color-difference component for each channel of pixels from the result of multiplication of the linear matrix coefficient to the pixel value of the pixel of each channel,

a luminance generation unit that generates a luminance such that a value obtained by subtracting the value of the color-difference component from the pixel value of the pixel of each channel is not smaller than a predetermined value and a suppression gain that suppresses the luminance,

a color fringe correction coefficient calculation unit that calculates the correction coefficient for correcting the value of the color-difference component so that the value of the color-difference component added to the pixel value of the pixel of each channel is equal to or greater than a value calculated based on the luminance and the suppression gain, and

a color fringe correction unit that corrects the pixel value of each channel by adding the value of the color-difference component corrected using the correction coefficient.

(4) The signal processing device according to any one of (1) to (3),

wherein the luminance and the correction coefficient are variable by a manual operation.

(5) A signal processing method in which when a linear matrix gain using a linear matrix coefficient is multiplied to a pixel value of an image signal of each channel, whereby an enhancement of color occurs in an image based on the image signal, the image signal in which a portion where the enhancement of color occurs is corrected for each channel is output based on a color-difference component separated from the result of multiplication of the linear matrix coefficient to the pixel value for each channel and a luminance calculated from the result.

(6) An imaging apparatus including:

an imaging device that photoelectrically converts incident light entering an imaging surface through an optical system to output an image signal;

a linear matrix operation unit that multiplies a linear matrix gain using a linear matrix coefficient with a pixel value of the image signal of each channel; and

an enhancement countermeasure unit in which when an enhancement of color occurs in an image based on the image signal due to multiplication of the linear matrix gain, the image signal in which a portion where the enhancement of color occurs is corrected for each channel is output based on a color-difference component separated from the result of multiplication of the linear matrix coefficient to the pixel value for each channel and a luminance calculated from the result.

(7) An imaging processing method including: multiplying a linear matrix gain using a linear matrix coefficient with a pixel value of the image signal of each channel; and

when an enhancement of color occurs in an image based on the image signal due to multiplication of the linear matrix gain, outputting the image signal in which a portion where the enhancement of color occurs is corrected for each channel based on a color-difference component separated from the result of multiplication of the linear matrix coefficient to the pixel value for each channel and a luminance calculated from the result.

The present disclosure contains subject matter related to that disclosed in Japanese Priority Patent Application JP 2011-024392 filed in the Japan Patent Office on Feb. 7, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
an enhancement countermeasure unit in which when a linear matrix gain using a linear matrix coefficient is multiplied to a pixel value of an image signal output for each channel by a pixel of an imaging device, whereby an enhancement of color occurs in an image based on the image signal, the image signal in which a portion where the enhancement of color occurs is corrected for each channel is output based on a color-difference component separated from the result of multiplication of the linear matrix coefficient to the pixel value for each channel and a luminance calculated from the result.

2. The signal processing device according to claim 1,
wherein when the enhancement of color is a color fringe of a specific color occurring around the image corresponding to a high luminance pixel or a collapse of gradation where a difference in gradation disappears, the enhancement countermeasure unit calculates a luminance that enhances a color opposite to the specific color, calculates a predetermined correction coefficient satisfying a relation such that a value obtained by multiplying the color-difference component added to a pixel value of the pixel of each channel with a predetermined correction coefficient is equal to or greater than a value obtained by multiplying the color-difference component with the luminance, and corrects the pixel value for each channel using the correction coefficient.

3. The signal processing device according to claim 2,
wherein the enhancement countermeasure unit includes
a color-difference component separation unit that separates a color-difference component for each channel of pixels from the result of multiplication of the linear matrix coefficient to the pixel value of the pixel of each channel,
a luminance generation unit that generates a luminance such that a value obtained by subtracting the value of the color-difference component from the pixel value of the pixel of each channel is not smaller than a predetermined value and a suppression gain that suppresses the luminance,
a color fringe correction coefficient calculation unit that calculates the correction coefficient for correcting the value of the color-difference component so that the value of the color-difference component added to the pixel value of the pixel of each channel is equal to or greater than a value calculated based on the luminance and the suppression gain, and
a color fringe correction unit that corrects the pixel value of each channel by adding the value of the color-difference component corrected using the correction coefficient.

4. The signal processing device according to claim 3,
wherein the luminance and the correction coefficient are variable by a manual operation.

5. A signal processing method in which when a linear matrix gain using a linear matrix coefficient is multiplied to a pixel value of an image signal of each channel, whereby an enhancement of color occurs in an image based on the image signal, the image signal in which a portion where the enhancement of color occurs is corrected for each channel is output based on a color-difference component separated from the result of multiplication of the linear matrix coefficient to the pixel value for each channel and a luminance calculated from the result.

6. An imaging apparatus comprising:
an imaging device that photoelectrically converts incident light entering an imaging surface through an optical system to output an image signal;
a linear matrix operation unit that multiplies a linear matrix gain using a linear matrix coefficient with a pixel value of the image signal of each channel; and
an enhancement countermeasure unit in which when an enhancement of color occurs in an image based on the image signal due to multiplication of the linear matrix gain, the image signal in which a portion where the enhancement of color occurs is corrected for each channel is output based on a color-difference component separated from the result of multiplication of the linear matrix coefficient to the pixel value for each channel and a luminance calculated from the result.

7. An imaging processing method comprising:
multiplying a linear matrix gain using a linear matrix coefficient with a pixel value of the image signal of each channel; and
when an enhancement of color occurs in an image based on the image signal due to multiplication of the linear matrix gain, outputting the image signal in which a portion where the enhancement of color occurs is corrected for each channel based on a color-difference component separated from the result of multiplication of the linear matrix coefficient to the pixel value for each channel and a luminance calculated from the result.
